(19) United States
(12) Patent Application Publication
(10) Pub. No.: US 2007/0177695 A1
(43) Pub. Date: Aug. 2, 2007

(54) Multi-user detection in cdma systems

(75) Inventors: Fathi M. Salem, Okemos, MI (US); Khurram Waheed, Richardson, TX (US)

Correspondence Address: HARNESS, DICKEY & PIERCE, P.L.C., P.O. BOX 828, BLOOMFIELD HILLS, MI, 48303, US

(73) Assignee: Board of Trustees of Michigan State University, East Lansing, MI (US)

(21) Appl. No.: 10/594,640

(22) PCT Filed: Mar. 30, 2005
(86) PCT No.: PCT/US05/10867

§ 371 Date: Sep. 28, 2006

Related U.S. Application Data
(60) Provisional application No. 60/558,174, filed on Mar. 31, 2004.

(51) Int. Cl. H04L 27/06

(52) U.S. Cl. 375/340

(57) ABSTRACT

A natural gradient Blind Multi User Detection (BMUD) network system and method adaptively estimates a set of matrices to counter a linear convolutive environment model. Feedforward and feedback network structures may be implemented, with or without matrix inversion. In other aspects, an adaptive weighting matrix is introduced into a RAKE structure, and the matrix is adaptively estimated using Principal Component Analysis (PCA) computational techniques and/or static Blind Source Recovery (BSR) computational techniques based on Independent Component Analysis (ICA).

### FIELD OF THE INVENTION

The present invention relates to multi-user detection in Code Division Multiple Access (CDMA) systems.

### BACKGROUND AND SUMMARY OF THE INVENTION

Code Division Multiple Access (CDMA) is based on spread-spectrum technology and is a dominant air interface for the proposed modern 3G and 4G wireless networks. The transmitted CDMA signals propagate through noisy multipath fading communication channels before arriving at the receiver of the user equipment (UE). In contrast to classical single-user detection (SUD) computational techniques, which do hot provide the requisite performance for modern high data rate applications, conventional multi-user detection (MUD) approaches require a lot of a-priori information not available to the UE.

The conventional detection schemes for CDMA signals only exploit second order statistics among user codes. Practically, however, the underlying user data symbol sequences are in general mutually (near-) “independent”. This is a key assumption, which enables the application of info-theoretic learning approaches such as information maximization and minimum mutual information to the realm of CDMA. The use of these computational techniques is justified since a wide sense stationary slowly fading multipath CDMA environment can be conveniently represented as a linear multi-channel convolution model. The received CDMA signal can be considered as a sum of several non-gaussian random variables generated by the linear convolutive transformations of statistically (near-) independent component user variables. This linear transformation accounts for the user spreading codes, the cell scrambling codes (in case of a cellular architecture), multiple channel paths and slowly fading channel effects. The present invention estimates a linear transformation to counteract, as “optimally” as possible, the effects of the channel transformation—resulting in the recovery of the original user signals under the constraint of knowing only the user's signature code (and the corresponding cell scrambling code for a two stage implementation).

Blind Source Recovery (BSR) is the process of estimating the original “independent” user-specific symbol sequences independent of, and even in the absence of, precise system/channel identification. In typical downlink signal processing, where many of the system parameters are unknown, including the number and type of codes for co-existing users at any instant of time, one can use the blind techniques for better estimation of the user-specific signals. Alternately, Blind Multi-User Detection (BMUD) computational techniques, based on the Natural Gradient Blind Source Recovery (BSR) techniques in both feedback and feedforward structures, can be used. The “quasi-orthogonality” of the spreading codes and the inherent “independence” among the various transmitted user symbol sequences form the basis of the proposed BMUD methods. The inventive structures and computational techniques demonstrate promising results as compared to the conventional techniques comprising, e.g., Matched Filter (MF), RAKE and the LMMSE methods. The inventive computational techniques can be implemented either using the batch or the more computationally efficient instantaneous update methods. Although batch implementations exhibit better performance, it is however accompanied by longer latency and require more involved implementation structures not suitable for a UE/MS. The remaining text focuses on the instantaneous (or on-line) performance of the BSR computational techniques, which exceeds the performance of other approaches. However, the invention can be easily described in the context of the batch processing.

This (on-line) detection technique can be easily extended to CDMA implementations, using relatively short scrambling codes, but becomes impractical in WCDMA downlink using long scrambling codes. In spite of the fact that very low bit error rates (BER) can be achieved with the BSR technique and the detection process does not even require the knowledge of user's own signature code, the recovered signal stream is at the symbol level with no explicit user identification. Further, inherent sign and permutation ambiguities exist in BSR (scaling is not relevant as the recovered streams are typically desired to have a constant amplitude (e.g., BPSK, QPSK etc.). User identification in BMUD is not possible unless some preamble or pilot data is transmitted periodically. This periodic requirement stems from the dynamic nature of the wireless communication scenario where users may dynamically enter or exit the system. The environment structure also varies widely due to the mobility of the MS/UE and the transient in the dynamic environment.

With these practical constraints in mind, new computational techniques are proposed by an infusion of info-theoretic learning computational techniques such as static Blind Source Recovery (BSR) (or Independent Component Analysis, ICA) and Principal Component Analysis (PCA) into the existing structure of a RAKE receiver. The purpose of this additional info-theoretic stage is to counter, as best as possible, the unmodeled multiple access interference (MAI) and the additive noise contribution of the channel. Further, use of a simple info-theoretic stage does not make the receiver structure too complex (in fact, it is simpler than most other proposed adaptive LMMSE implementations. RAKE-PCA uses up to second order statistics, as compared to RAKE-BSR, which utilizes higher order statistics. This results in slightly simpler update structure for the RAKE-PCA, but the performance of the RAKE-BSR is found to be better than RAKE-PCA. Further, assuming the score-function for the ICA update law to be chosen properly, the resulting equalization matrix in case of RAKE-BSR has relatively smaller element values (energy) as compared to the corresponding matrix for RAKE-PCA, which can be translated to the need of fewer memory bits for storage of coefficients. Lastly, both RAKE-BSR and RAKE-PCA use all the available user information, so that there are no issues of user identification in this case. The main advantage of both the adaptive RAKE-BSR and RAKE-PCA computational techniques is the improved BER performance for the UE/MS without the need of any additional information than what a standard RAKE receiver already has. The proposed computational techniques can be applied directly to both generic direct sequence (DS-)CDMA and modern multi-cellular 3G (UMTS) and beyond CDMA systems. The described processes can also be extended to other forms of spread spectrum system.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a block diagram illustrating a typical signal generation model for a QPSK DS-CDMA system;

FIG. 2 is a block diagram illustrating a feedforward demixing structure in accordance with a first embodiment of the present invention;

FIG. 3 is a block diagram illustrating a feedback demixing structure in accordance with a second embodiment according to the present invention; and

FIG. 4 is a block diagram illustrating a feedback demixing structure in accordance with a third embodiment according to the present invention.

### DETAILED DESCRIPTION OF THE PREFERRED EMBODIMENTS

The following description of the preferred embodiments is merely exemplary in nature and is in no way intended to limit the invention, its application, or uses.

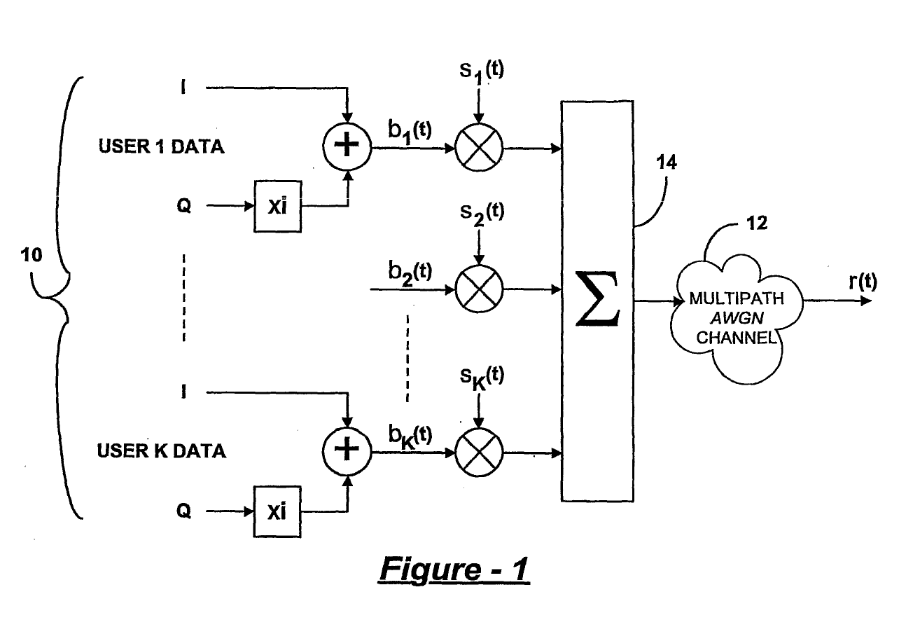

The present invention includes three embodiments of demixing structures providing new MUD detection systems and methods, and two additional new types of detectors derived using BSR techniques. The new MUD detection systems and methods are discussed as Natural Gradient Blind Multi-User Detection (BMUD) computational systems and methods. The two new detectors are RAKE-Blind Source Recovery (RAKE-BSR) and RAKE-Principal Component Analysis (RAKE-PCA) Detectors. These detection systems, methods, and detectors are discussed with reference to a convenient convolutive signal model representation of DS-CDMA systems discussed with reference to FIG. 1.

In a typical downlink synchronous DS-CDMA system employed for indoor ATM and certain ad-hoc wireless networks, each user's data 10 is spread using an individual signature waveform (or spreading code), then the data 10 for all users is combined and transmitted over multipath AWGN channel 12 by the Base Station (BS) 14. Each User Equipment (UE) or Mobile station (MS) synchronizes itself with the BS using the broadcast synchronization/pilot channels; once synchronized, the BS and UE/MS can communicate on the traffic channel (comprised of both data and control streams), assuming the data transmission to be QPSK, i.e., comprised of two composite data channels created by a serial-to-parallel (S/P) stage, which are constellated in quadrature. At the UE/MS receiver, the received signal is first passed through a chip-matched filter and sampled at chip rate.

Considering a total of K active users in an L multipath environment and N transmitted symbols during the observation frame T_{F}, the received signal is given by

$$r ( t ) = {\sum }_{n = 1}^{N} {\sum }_{k = 1}^{K} {\sum }_{l = 0}^{L - 1} \sqrt{{ɛ}_{kn} ( t )} {b}_{k} ( n ) {h}_{l} ( t ) {s}_{k} ( t - n T - {τ}_{l} ) + n ( t ) \qquad ( 1 )$$

where εₖₙ is the energy of the n^{th} symbol for the k^{th} user, bₖ(n)ε{±1±i} is the n^{th} complex symbol for the k^{th} user, hₗ and τₗ are the l^{th} path's gain co-efficients and delay, respectively. n(t) is the additive noise and sₖ(t) is the k^{th} user's signature code (or spreading sequence) generated by

$${s}_{k} ( t ) = {\sum }_{m = 0}^{G - 1} {α}_{k} ( m ) p ( t - m {T}_{c} ) ; {α}_{k} ( m ) ∈ \{ - 1 , 1 \} ; 0 \leq m \leq G - 1 \qquad ( 2 )$$

αₖ(m) is a real spreading sequence (i.e., any of the standard CDMA PN codes, such as the Gold, Walsh-Hadamard, Kasami sequence, etc.) for the k^{th} user containing G chips per symbol, i.e., G=T_{b}/T_{c}, p(t) is a chipping pulse of duration T_{c}., and where T_{b} being the symbol period.

Under the assumption of time-invariance, the model (1) can be more compactly written in a vector-matrix format as
r̅=HS b̅+ n̅ (3)
where, H is a (NG+L−1)×NG multipath propagation co-efficient matrix containing the channel coefficients. S is a NG×NK block diagonal matrix with the matrix of spreading codes forming the diagonal elements, b̅ is an NK −d vector containing the user symbols, while n̅ is the (NG+L−1)−d channel noise vector with covariance matrix Q. The structure of the above defined matrices and vectors is given by

$$⌊ \begin{matrix}{h}_{0} & 0 & ⋯ & 0 \\ ⋮ & ⋰ & & ⋮ \\ {h}_{L - 1} & & ⋰ & 0 \\ 0 & ⋰ & & {h}_{0} \\ ⋮ & ⋰ & ⋰ & ⋮ \\ 0 & ⋯ & 0 & {h}_{L - 1}\end{matrix} ⌋$$

$$S = diag ⌊ \begin{matrix}\overline{S} & \overline{S} & ⋯ & \overline{S}\end{matrix} ⌋ , \overline{S} = [ \begin{matrix}{s}_{1} & {s}_{2} & ⋯ & {s}_{k}\end{matrix} ]$$

$$\overline{b} = {⌊ \begin{matrix}{b ( 1 )}^{T} & {b ( 2 )}^{T} & ⋯ & {b ( N )}^{T}\end{matrix} ⌋}^{T} , \\ b ( n ) = {⌊ \begin{matrix}\sqrt{{ɛ}_{1 n}} {b}_{1} ( n ) & \sqrt{{ɛ}_{2 n}} {b}_{2} ( n ) & ⋯ & \sqrt{{ɛ}_{k n}} {b}_{K} ( n )\end{matrix} ⌋}^{T}$$

The compact linear model (3) is useful in deriving the closed form expression for linear detectors such as matched filter (MF), linear minimum mean squared error (LMMSE) etc. for recovery of the transmitted symbol train for a desired user. However, the primary disadvantage of this model is the prohibitive dimensions of the constituent matrices, especially with longer frame durations and larger G, the matrices become excessively large, making this model unsuitable for any real-time implementation at UE/MS.

Alternately, the signal model can be represented as a linear convolutive model, i.e., during the symbol time, the received chip data is constituted of the chips corresponding to the currently transmitted symbol, its delayed multipath components as well as delayed chips from some previously transmitted symbols and the channel added noise and artifacts. In this formulation, G chips arriving at the UE/MS during the n^{th} symbol time are computed as the sum of the chips from L multipaths of the n^{th} transmitted symbol and the multipath components of the previous J−1 symbols (n−1, . . . , n−J−1), where
J=[max(τ_{L})/G]+1 (4)
and max(τ_{L}) being the maximum chip delay in L multipaths (rounded up). The n^{th} received symbol data can be expressed as

$${r}_{n} ( t ) = {\sum }_{k = 1}^{K} {b}_{k} ( n ) \sqrt{{ɛ}_{k n} ( t )} {\sum }_{l = 0}^{L - 1} {h}_{l} ( t ) {s}_{k} ( t - n T - {τ}_{l} ) + {n}_{n} ( t ) + {\sum }_{j = 1}^{J - 1} {\sum }_{k = 1}^{K} {b}_{k} ( n - j ) \sqrt{{{ɛ}_{k} ( n - j )}^{( t )}} {\sum }_{l = 0}^{L - 1} {h}_{l} ( t ) {s}_{k} ( t - ( n - j ) T - {τ}_{l} ) ; \\ nT \leq t \leq ( n + 1 ) T \qquad ( 5 )$$

Under the assumption that max(τ_{L})≦G, the above model can be expressed just in terms of the current and the preceding symbols. That is, the multipaths with delay greater than symbol period either do not exist or are weak enough to be ignored. In this case, the output samples of the chip-matched filter can be written as:

$${r}_{n} = {\sum }_{k = 1}^{K} [ {b}_{k n} \sqrt{{ɛ}_{k n} ( t )} {\sum }_{l = 0}^{L - 1} {h}_{l} {\overline{z}}_{k l} + {b}_{k , n - 1} \sqrt{{ɛ}_{k , n - 1} ( t )} {\sum }_{l = 0}^{L - 1} {h}_{l} {\underline{z}}_{k l} ] + {n}_{n} \qquad ( 6 )$$

where, z̅ₖₗ and zₖₗ are G−d early and late code vectors, i.e.,

$$\begin{matrix}{\overline{z}}_{k l} = {⌊ \begin{matrix}\underbrace{0 ⋯ 0}_{{τ}_{l}} & {s}_{k} [ 1 ] & ⋯ & {s}_{k} [ G - {τ}_{l} ]\end{matrix} ⌋}^{T} & ( 7 ) \\ {\underline{z}}_{k l} = {⌊ \begin{matrix}{s}_{k} ⌊ G - {τ}_{l} + 1 ⌋ & ⋯ & {s}_{k} [ G ] \underbrace{0 ⋯ 0}_{G - {τ}_{l}}\end{matrix} ⌋}^{T} & ( 8 )\end{matrix}$$

and τₗ is the discretized delay satisfying the constraint 0≦τₗ≦T_{b}. Imposing time invariant constraints, the multipath slowly fading environment model (6) can be represented in the form
rₙ=H₀bₙ+H₁bₙ₋₁+nₙ (9)
where bₙ and bₙ₋₁ are the K−d vectors of current and previous symbol for all the K users. H₀ and H₁ are G×K mixing matrices with the structure

$${H}_{0} = ⌊ \begin{matrix}{H}_{0 , 0} & {H}_{0 , 1} & ⋯ & {H}_{0 , K}\end{matrix} ⌋ , {H}_{1} = ⌊ \begin{matrix}{H}_{1 , 0} & {H}_{1 , 1} & ⋯ & {H}_{1 , K}\end{matrix} ⌋$$

$$such that \begin{matrix}{H}_{0 , k} = \sqrt{{ɛ}_{0}} {\sum }_{l = 0}^{L - 1} {h}_{l} {\overline{z}}_{k l} & ( 10 ) \\ {H}_{1 , k} = \sqrt{{ɛ}_{1}} {\sum }_{l = 0}^{L - 1} {h}_{l} {\underline{z}}_{k l} & ( 11 )\end{matrix}$$

and the twosomes ε₀, ε₁ represent the energy of the current and the previous symbol respectively.

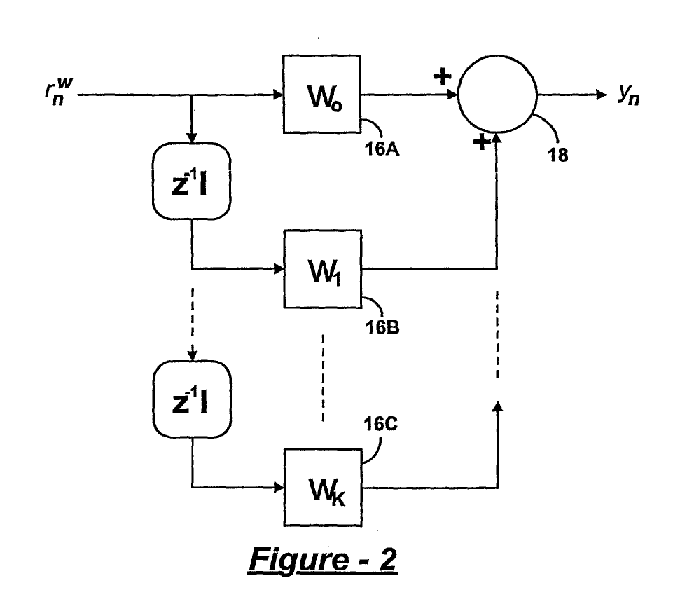

The Natural Gradient Blind Multi-User Detection (BMUD) system and method is discussed below with reference to FIGS. 2-4. Blind Multi-user Detection (BMUD) is the process to blindly estimate all the user symbol sequences directly from the received composite CDMA signal using the Blind Source Recovery (BSR) techniques. BSR framework implies recovery of original signals from environments that may include transient, convolution and even non-linearity. The linear BSR computational techniques have been developed for linear convolutive mixing environments by the minimization of mutual information (e.g., using the Kullback Lieblar Divergence) using the natural gradient subject to the structural constraints of a recovery network. The natural gradient BMUD network can be adapted either in the feedforward or the feedback configuration, in which case the proposed BMUD system and method adaptively estimates a set of (filter weight) matrices to counter the linear convolutive environment model (9). In each case, the input receives either the linear convolutive environment model rₙ or its whitened version rₙ^{w} (of the linear convolutive environment model rₙ). Parametric matrices 16A-16C W₀-Wₖ are adapted to estimate independent user symbols yₙ at an n^{th} instant based on the linear convolutive environment model rₙ or its whitened version rₙ^{w}. A decision stage 18 sums the component mappings to generate the output yₙ to provide the corresponding user symbol estimates \hat{b}ₙ also at the n^{th} instant.

The justification for BMUD computational techniques is based on the convenient convolutive signal model representation of DS-CDMA systems, see (9), and the reasonable assumption that the various transmitted user symbol sequences are mutually “independent” as they are generated independently of each other. In this framework, both the transmitted sequence and the mixing matrices in the model (9) are unknown to the user. The only known entity to the user is the self-identification code. Other available prior information is the nature of transmitted data, which in standard CDMA systems is typically assumed to be quaternary sub-guassian distribution, e.g., QPSK data distorted by the multipath channel and additive noise. There exists enough information to apply the info-theoretic natural gradient Blind Source Recovery (BSR) system and method for BMUD in this case.

Further assume that the DS-CDMA channel is not over-saturated and K≦G. The proposed BMUD computational techniques do not require any pre-whitening of received data. However, in most modern WCDMA, G is chosen to be large enough to maximize spreading gain and so as not to limit the number of users—in general K<G. Therefore, it is computationally advantageous to pre-process received data for dimension reduction to K which is the actual number of principal independent symbol sequences (or users) in the received data. The process of pre-whitening will also remove the second order dependence among the received data samples and some of the additive noise. The data pre-whitening can be achieved either online using adaptive principal component analysis (PCA) computational techniques or it may be done algebraically by using a large batch (say N samples) of received data, i.e.,
R=[r₁r₂ . . . r_{N-1}r_{N}]
with the correlation matrix

$${Λ}_{C} = \frac{1}{N - 1} R {R}^{T}$$

Then the whitening is achieved using the filtering matrix
W=D^{-1/2}V^{T}
where
D: represents the K-dim matrix of principle eigenvalues of the data correlation matrix Λ_{C}.
V: represents the K×N matrix of principle eigen vectors of the data correlation matrix Λ_{C}.

The whitened version of (9) is given by
rₙ^{w}=W(H₀bₙ+H₁bₙ₋₁+nₙ)≡ H̅₀bₙ+ H̅₁bₙ₋₁ (12)
where rₙ^{w} represents the K−d whitened data received during the n^{th} symbol time and H̅₀, H̅₁ represent the equivalent K×K convolutive mixing matrices for the current and the previous symbol (For compatibility, rₙ is assumed to be N−d.)

BMUD computational techniques blindly adapt a set of matrices to output the independent user symbols estimate yₙ at the n^{th} instant. This is followed by a decision stage to interpret, as best as possible, yₙ and estimate the corresponding user symbol estimates \hat{b}ₙ also at the n^{th} instant.
\hat{b}ₙ=ψ(yₙ) (13)
where ψ(•): represents the (nonlinear) decision stage.

For the feedforward configuration discussed with reference to FIG. 2, the BMUD stage output is computed as

$${y}_{n} = {W}_{0} {r}_{n}^{w} + {\sum }_{k = 1}^{K} {W}_{k} {r}_{n - k}^{w} \qquad ( 14 )$$

where, in this case, K refers to the number of feedforward coefficient matrices.

The update laws for this feedforward structure can be derived. For the feedforward parametric matrices W₀ and Wₖ, the update laws are
ΔW₀∝(I−φ(yₙ)yₙ^{H})W₀ (15)
and
ΔWₖ∝(I−φ(yₙ)yₙ^{H})Wₖ−φ(yₙ)(rₙ₋ₖ^{W})^{H} (16)
where φ(•) is an element-wise acting score function, and I is a K−d identity matrix, and k=1,2, . . . K.

For the initialization of the computational technique, W₀ is chosen to be either an identity or a diagonally dominantly matrix, while all other matrices Wₖ are initialized to have either random elements with a very small variance or as a matrix of all zeros. Note that no matrix inversion is required for the feedforward computational technique.

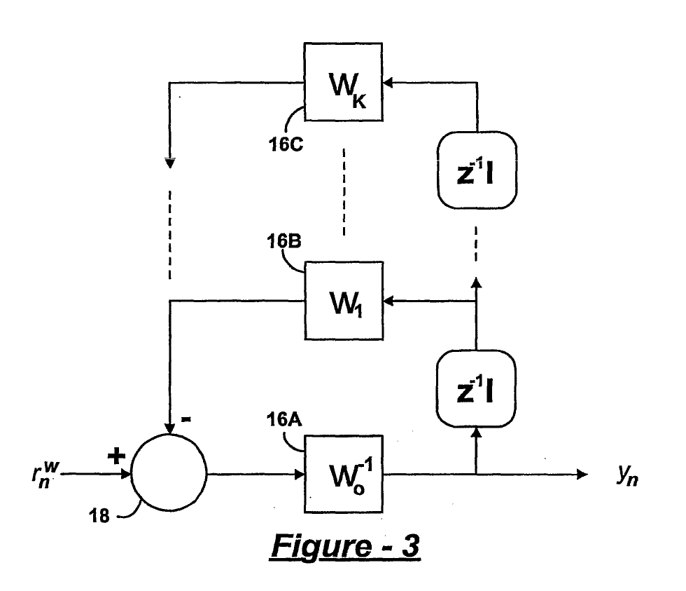

In a second embodiment discussed with reference to FIG. 3 and hereinafter referred to as feedback configuration I, the output is estimated by

$${y}_{n} = {W}_{0}^{- 1} ( {r}_{n}^{w} - {\sum }_{k = 1}^{K} {W}_{k} {y}_{n - k} ) \qquad ( 17 )$$

The update law for this structure using the natural gradient are given for the matrix W₀ by
ΔW₀∝−W₀(I−φ(yₙ)yₙ^{H}) (18)
While for the feedback matrices Wₖ, the update law is
ΔWₖ∝W₀(φ(yₙ)yₙ₋ₖ^{H}) (19)
for k=1,2, . . . , K. The matrices in this case are also initialized in a fashion similar to the feedforward case. However, note that at least one matrix inversion is required in this formulation.

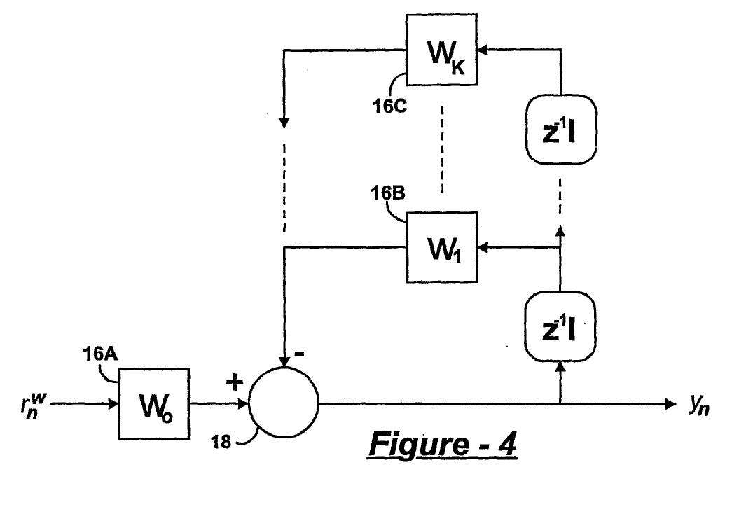

In a third embodiment discussed with reference to FIG. 4 and hereinafter referred to as feedback configuration II, the feedback configuration implements the feedback structure without the need for any matrix inversion. For this feedback configuration II, the BMUD stage output is computed as

$${y}_{n} = {W}_{0} {r}_{n}^{w} - {\sum }_{k = 1}^{K} {W}_{k} {y}_{n - k} \qquad ( 20 )$$

The update laws for this feedback structure are given by
ΔW₀∝(I−φ(yₙ)yₙ^{H})W₀ (21)
ΔWₖ∝(I−φ(yₙ)yₙ^{H})Wₖ+φ(yₙ)yₙ₋ₖ^{H} (22)
again, k=1,2, . . . , K, where K here is the maximum number of filter matrices/taps.

In case the channel is known or can be estimated, the performance of the proposed BMUD computational techniques may be adjusted by the diagonalization of the absolute value of the global transfer function. The global transfer function presents the combined effect of the complex mixing and demixing transfer functions. For the two symbol convolutive models for the case of max(τ_{L})≦G. the global transfer function for the natural gradient computational techniques in the z-domain are given by:
G=G₀+G₁z⁻¹+G₂z⁻² (23)
where, for the feedforward configuration
G₀=W₀ H̅₀=W₀WH₀,
G₁=W₀ H̅₁+W₁ H̅₀=W₀WH₁+W₁WH₀ and (24)
G₂=W₁ H̅₁=W₁WH₁
while, for the feedback configuration I
G₀=W₀⁻¹ H̅₀=W₀⁻¹WH₀,
G₁=W₀⁻¹( H̅₁−W₁)=W₀⁻¹(WH₁−W₁) and (25)
G₂=0
and for the feedback configuration II
G₀=W₀ H̅₀=W₀WH₀,
G₁=W₀ H̅₁+W₁=W₀WH₁+W₁ and (26)
G₂=0

The proposed BMUD computational techniques as formulated result in recovery of the user symbols directly. The computational techniques can be conveniently applied to DS-CDMA systems using only user-specific spreading sequences. They may also be extended to other CDMA systems using relatively short scrambling codes, though the dimension of matrices may still become large for DSP implementations in a UE/MS. The WCDMA system uses long codes in the downlink, making the application of these computational techniques impractical because of the requisite dimension of the demixing network matrices.

The RAKE-Blind Source Recovery (RAKE-BSR) and RAKE-Principal Component Analysis (RAKE-PCA) Detectors are now described. RAKE-BSR and RAKE-PCA are two new proposed adaptive detectors, which utilize the same knowledge as a RAKE receiver. An info-theoretic adaptive weighting matrix of dimension G×G is introduced into the RAKE structure, which gives a big performance boost to the RAKE receiver. The performance of RAKE-BSR/RAKE-PCA exceeds the performance of LMMSE detectors under the conditions of high network congestion, imprecise channel estimation, and unmodeled inter-cellular interference etc. The closed form structure of these proposed detectors is given by

$${{b}^{\hat{\_}}}_{i , RAKE - ICA / PCA} = \{ \begin{matrix}{S}_{i}^{H} \tilde{W} {\hat{H}}^{H} \overline{r} & for DS \text{-} CDMA Systems \\ {S}_{i}^{H} {C}^{H} \tilde{W} {\hat{H}}^{H} \overline{r} & for WCDMA Systems\end{matrix} \qquad ( 27 )$$

where \tilde{W}=diag[AA . . . A], and A is the G×G matrix that is adaptively estimated either using static BSR (ICA) or PCA computational techniques.

It is proposed to adapt the matrix A using the natural gradient update laws. However, there exist several other methods for ICA/PCA and any other suitable method may be used for these adaptations. This blind adaptation of the A matrix has several advantages and improves the performance of the overall equalization process in several ways. Firstly, it can dynamically counter artifacts in the estimated channel co-efficients Ĥ. Secondly, the channel estimation process (as in RAKE receivers) may be limited by the structure (such as the number of fingers) and may estimate only a few of the dominant channel parameters. The Ŵ stage tends to counteract this anomaly, as best as possible, and provides better performance than LMMSE in such cases. Thirdly, this adaptive stage minimizes the effect of the additive channel noise, which may have an intricate underlying unmodeled structure. Lastly, the natural gradient ICA/PCA computational techniques inherently reduce near-far problems by removing any ill conditioning in the signal space for all the users in the system. This results in all the mobile users in the system to have a BER performance similar to the average BER performance of the downlink channel. The matrix A is adaptively estimated using the update laws

$$\begin{matrix}A ( k + 1 ) = A ( k ) + {η}_{k} Δ A ( k ) \\ where & ( 28 ) \\ Δ A ( k ) = \{ \begin{matrix}( I - φ ( y ( k ) ) {y ( k )}^{H} ) A ( k ) & for static BSR ( or ICA ) \\ ( I - y ( k ) {y ( k )}^{H} ) A ( k ) & for PCA\end{matrix} & ( 29 )\end{matrix}$$

and φ(•) is a nonlinear score function which depends on the underlying distribution structure of the signals involved. For QPSK signal, a suitable score-function is
φᵢ(yᵢ)=vᵢyᵢ−αᵢ(tan h(βᵢRe{yᵢ})+tan h(βᵢIm{yᵢ})) (30)

Of these proposed RAKE-BSR/RAKE-PCA structures, RAKE-BSR exhibits relatively faster and more stable convergence. However, in standard CDMA systems the underlying code structure is chosen to be “orthogonal”, and thus RAKE-PCA may exhibit lower BER solution if the channel impairments are linear. Note that in (27), if the channel estimate Ĥ is either not available or changes very dynamically, the detector can be estimated without using the channel estimate and the structure reduces to Matched Filter BSR/PCA, i.e.,

$${{b}^{\hat{\_}}}_{i , MF - BSR / PCA} = \{ \begin{matrix}{S}_{i}^{H} \tilde{W} \overline{r} & for DS \text{-} CDMA Systems \\ {S}_{i}^{H} {C}^{H} \tilde{W} \overline{r} & for WCDMA Systems\end{matrix} \qquad ( 31 )$$

The performance of this structure is better than Matched Filter alone, and approaches the performance of a RAKE receiver as the underlying matrix A converges.

The description of the invention is merely exemplary in nature and, thus, variations that do not depart from the gist of the invention are intended to be within the scope of the invention. Such variations are not to be regarded as a departure from the spirit and scope of the invention.

1. A natural gradient Blind Multi User Detection (BMUD) network system that adaptively estimates a set of matrices to counter a linear convolutive environment model rₙ, the system comprising:
an input receptive of at least one of the linear convolutive environment model rₙ or a whitened version rₙ^{w} of the linear convolutive environment model rₙ;
parametric matrices W₀ and Wₖ (k=1,2, . . . K) adaptable to estimate independent user symbols yₙ at an n^{th} instant based on at least one of the linear convolutive environment model rₙ or the whitened version rₙ^{w} of the linear convolutive environment model rₙ; and
a decision stage interpreting yₙ and estimating corresponding user symbol estimates \hat{b}ₙ also at the n^{th} instant.

2. The system of claim 1, wherein the system is networked in a feedforward configuration.

3. The system of claim 2, further comprising a recovery stage adapted to compute yₙ according to:
$${y}_{n} = {W}_{0} {r}_{n}^{w} + {\sum }_{k = 1}^{K} {W}_{k} {r}_{n - k}^{w} ,$$
where K is an estimate of a number of a previous symbols needed for computation of yₙ, with K being greater than or equal to J:=integer (max (Tau_L))+1).

4. The system of claim 2, wherein the parametric matrices W₀ and Wₖ have update laws according to:
ΔW₀∝(I−φ(yₙ)yₙ^{H})W₀; and
ΔWₖ∝(I−φ(yₙ)yₙ^{H})Wₖ−φ(yₙ)(rₙ₋ₖ^{W})^{H},
where φ(•) is an element-wise acting score function, I is a K−d identity matrix, and k=1,2, . . . K.

5. The system of claim 2, wherein W₀ is initially chosen to be at least one of an identity or a diagonally dominantly matrix, while all other matrices Wₖ are initialized to have at least one of random elements with a very small variance or as matrices of all zeros.

6. The system of claim 1, wherein the system is networked in a feedback configuration.

7. The system of claim 6, wherein the recovery stage is adapted to compute yₙ according to:
$${y}_{n} = {W}_{0}^{- 1} ( {r}_{n}^{w} - {\sum }_{k = 1}^{K} {W}_{k} {y}_{n - k} ) .$$

8. The system of claim 6, wherein the parametric matrices W₀ and Wₖ have update laws according to:
ΔW₀∝−W₀(I−φ(yₙ)yₙ^{H}); and
ΔWₖ∝W₀(φ(yₙ)yₙ₋ₖ^{H}),
where φ(•) is an element-wise acting score function, I is a K−d identity matrix, and k=1,2, . . . K, with K being an estimate of a number of previous symbols needed for computation of the parametric matrices, K being greater than or equal to J:=integer (max (Tau_L))+1).

9. The system of claim 1, wherein the system is networked in a feedback configuration without need for any matrix inversion.

10. The system of claim 9, wherein the decision stage is adapted to compute yₙ according to:
$${y}_{n} = {W}_{0} {r}_{n}^{w} - {\sum }_{k = 1}^{K} {W}_{k} {y}_{n - k} .$$

11. The system of claim 9, wherein the parametric matrices W₀ and Wₖ have update laws according to:
ΔW₀∝(I−φ(yₙ)yₙ^{H})W₀; and
ΔWₖ∝(I−φ(yₙ)yₙ^{H})Wₖ+φ(yₙ)yₙ₋ₖ^{H},
where φ(•) is an element-wise acting score function, and I is a K−d identity matrix.

12. The system of claim 1, further comprising a whitening filter preprocessing received data for dimension reduction to K, which is an actual number of principal independent symbol sequences in the received data, and to remove second order dependence among received data samples and additive noise.

13. The system of claim 12, wherein the whitening filter whitens data online using adaptive principle component analysis computational techniques.

14. The system of claim 13, wherein the whitening filter whitens data using an algebraic PCA estimate over a large batch of received data including N samples according to:
R=└r₁r₂ . . . ^{r}N−1 ^{r}N┘
with a data correlation matrix
$${Λ}_{C} = \frac{1}{N - 1} R {R}^{T} .$$

15. The system of claim 14, wherein the filter achieves the whitening using a filtering matrix according to:
W=D^{-1/2}V^{T},
where D represents a K-dim matrix of principle eigenvalues of the data correlation matrix Λ_{C}, and V represents a K×N matrix of principle eigen vectors of the data correlation matrix Λ_{C}, with K representing a number of users.

16. The system of claim 12, wherein the filter is adapted to calculate the whitened version rₙ^{w} of the linear convolutive environment model rₙ according to:
rₙ^{w}=W(H₀bₙ+H₁bₙ₋₁+nₙ)≡ H̅₀bₙ+ H̅₁bₙ₋₁,
and the linear convolutive environment model rₙ is represented according to:
rₙ=H₀bₙ+H₁bₙ₋₁+nₙ
where bₙ and bₙ₋₁ are the K−d vectors of current and previous symbols for all the K users, H₀ and H₁ are K×K mixing matrices with the structure
H₀=└H_{0,0} H_{0,1} . . . H_{0,K}┘, H₁=└H_{1,0} H_{1,1} . . . H_{1,K}┘ such that
$${H}_{0 , k} = \sqrt{{ɛ}_{0}} {\sum }_{l = 0}^{L - 1} {h}_{l} {\overline{z}}_{k l} , {H}_{l , k} = \sqrt{{ɛ}_{1}} {\sum }_{l = 0}^{L - 1} {h}_{l} {\underline{z}}_{k l}$$
and ε_{0,} ε₁ represent the energy of the current and the previous symbol respectively.

17. An adaptive detector utilizing knowledge utilized by a RAKE receiver, comprising:
an adaptive weighting matrix introduced into a RAKE structure, wherein the matrix is adaptively estimated using at least one of Principal Component Analysis (PCA) computational techniques and static Blind Source Recovery (BSR) computational techniques.

18.-23. (canceled)

24. A natural gradient Blind Multi User Detection (BMUD) method that adaptively estimates a set of matrices to counter a linear convolutive environment model rₙ, comprising:
receiving at least one of the outputs of the linear convolutive environment model rₙ or a whitened version rₙ^{w} of the outputs of the linear convolutive environment model rₙ;
adapting parametric matrices W₀ and Wₖ to estimate independent user symbols yₙ at an n^{th} instant based on at least one of the linear convolutive environment model rₙ and the whitened version rₙ^{w} of the linear convolutive environment model rₙ; and
interpreting yₙ and estimating corresponding user symbol estimates \hat{b}ₙ also at the n^{th} instant.

25. The method of claim 24, further comprising employing a feedforward network configuration.

26. The method of claim 25, further comprising computing yₙ according to:
$${y}_{n} = {W}_{0} {r}_{n}^{w} + {\sum }_{k = 1}^{K} {W}_{k} {r}_{n - k}^{w} .$$

27. The method of claim 25, further comprising updating the parametric matrices W₀ and Wₖ via update laws according to:
ΔW₀∝(I−φ(yₙ)yₙ^{H})W₀; and
ΔWₖ∝(I−φ(yₙ)yₙ^{H})Wₖ−φ(yₙ)(rₙ₋ₖ^{W})^{H},
where φ(•) is an element-wise acting score function, and I is a K−d identity matrix.

28. The method of claim 25, further comprising:
initializing W₀ to be at least one of an identity or a diagonally dominant matrix; and
initializing all other matrices Wₖ to have at least one of random elements with a very small variance or as matrices of all zeros.

29. The method of claim 24, further comprising employing a feedback network configuration.

30. The method of claim 29, further comprising computing yₙ according to:
$${y}_{n} = {W}_{0}^{- 1} ( {r}_{n}^{w} - {\sum }_{k = 1}^{K} {W}_{k} {y}_{n - k} ) .$$

31. The method of claim 29, updating the parametric matrices W₀ and Wₖ via update laws according to:
ΔW₀∝−W₀(I−φ(yₙ)yₙ^{H}); and
ΔWₖ∝W₀(φ(yₙ)yₙ₋ₖ^{H}),
where φ(•) is an element-wise acting score function, and I is a K−d identity matrix.

32. The method of claim 24, further comprising employing a feedback network configuration without need for any matrix inversion.

33. The method of claim 32, further comprising computing yₙ according to:
$${y}_{n} = {W}_{0} {r}_{n}^{w} - {\sum }_{k = 1}^{K} {W}_{k} {y}_{n - k} .$$

34. The method of claim 32, further comprising updating the parametric matrices W₀ and Wₖ via update laws according to:
ΔW₀∝(I−φ(yₙ)yₙ^{H})W₀; and
ΔWₖ∝(I−φ(yₙ)yₙ^{H})Wₖ+φ(yₙ)yₙ₋ₖ^{H},
where φ(•) is an element-wise acting score function, and I is a K−d identity matrix.

35. The method of claim 24, further comprising preprocessing received data for dimension reduction to K, which is an actual number of principal independent symbol sequences in the received data, and to remove second order dependence among received data samples and additive noise.

36. The method of claim 35, further comprising whitening data online using adaptive principle component analysis computational techniques.

37. The method of claim 36, further comprising whitening data using an algebraic PCA estimate over a large batch of received data including N samples according to:
R=└r₁r₂ . . . ^{r}N−1 ^{r}N┘
with a data correlation matrix
$${Λ}_{C} = \frac{1}{N - 1} R {R}^{T} .$$

38. The method of claim 36, further comprising employing a filtering matrix according to:
W=D^{-1/2}V^{T}
where D represents a K-dim matrix of principle eigenvalues of the data correlation matrix Λ_{C}, and V represents a K×M matrix of principle eigen vectors of the data correlation matrix Λ_{C}.

39. The method of claim 35, further comprising calculating the whitened version rₙ^{w} of the linear convolutive environment model rₙ according to:
rₙ^{w}=W(H₀bₙ+H₁bₙ₋₁+nₙ)≡ H̅₀bₙ+ H̅₁bₙ₋₁,
wherein the linear convolutive environment model rₙ is represented according to:
rₙ=H₀bₙ+H₁bₙ₋₁+nₙ
where bₙ and bₙ₋₁ are the K−d vectors of current and previous symbol for all the K users, H₀ and H₁ are G×K mixing matrices with the structure
H₀=└H_{0,0} H_{0,1} . . . H_{0,K}┘, H₁+└H_{1,0} H_{1,1} . . . H_{1,K}┘ such that
$${H}_{0 , k} = \sqrt{{ɛ}_{0}} {\sum }_{l = 0}^{L - 1} {h}_{l} {\overline{z}}_{k l} , {H}_{l , k} = \sqrt{{ɛ}_{1}} {\sum }_{l = 0}^{L - 1} {h}_{l} {\underline{z}}_{k l} ,$$
and ε_{0,} ε₁ represent the energy of the current and the previous symbol respectively.

40. An adaptive detection method, comprising:
introducing an adaptive weighting matrix into a RAKE structure, wherein the matrix is adaptively estimated using at least one of Principal Component Analysis (PCA) computational techniques or static Blind Source Recovery (BSR) computational techniques based on Independent Component Analysis (ICA).

41.-45. (canceled)
